(19) United States
(12) Patent Application Publication
(10) Pub. No.: US 2012/0023170 A1
(43) Pub. Date: Jan. 26, 2012

(54) Decision Bubbles

(75) Inventors: Carole-Ann Matignon, San Jose, CA (US); Carlos Serrano-Morales, Sunnyvale, CA (US)

(73) Assignee: SPARKLING LOGIC, INC., Dover, DE (US)

(21) Appl. No.: 13/187,387

(22) Filed: Jul. 20, 2011

Related U.S. Application Data
(60) Provisional application No. 61/366,142, filed on Jul. 20, 2010.

(51) Int. Cl. G06F 15/16

(52) U.S. Cl. 709/205

(57) ABSTRACT

The present invention is a method for business users to collaborate on a decision within a decision bubble. A decision bubble is a specifically created environment in which a group of collaborators can interact with the purpose of creating and modifying decisions or business rules, and through which the system captures interactions between collaborators and enables traceability with respect to the resulting decisions. Using a lightweight business process, a decision bubble is initiated by a business user, the bubble owner, and can have in its scope any section of the decisions being managed. The bubble owner may issue invitations to the bubble to collaborators, some of which may be suggested by the system using a reputation system that scores users with respect to types of tasks and entities. The decision bubble contains all the contextual information required for the bubble collaborators to collaborate on the implementation or modifications of the decisions or rules. In one embodiment, only the users within the bubble can see and manage the newly created or modified decisions or rules. When the changes are deemed final by the bubble collaborators, the bubble may be merged back to the current state of the decisions, and the system keeps track of all interactions that led to the changed decisions, as well as all participants to it.

### CROSS REFERENCE TO RELATED APPLICATIONS

This application claims priority benefit to U.S. Provisional Application No. 61/366,142, entitled “Decision Bubbles” filed Jul. 20, 2010, which is incorporated by reference in its entirety herein as if it was put forth in full below.

### BACKGROUND OF THE INVENTION

Decision logic elicitation requires knowledge provided by Subject Matter Experts (SMEs) about the business side as well as technical skills to understand how to codify such expertise into a business rule representation. This fact alone often limits the size of the talent pool capable of successfully accomplishing corresponding tasks. Assuming that enough people are trained to understand both aspects of the elicitation effort, another challenge faced is how to effectively collaborate.

The nature of the decision making process involves real-life discussions between coworkers within and across organizational units and functional roles. As a result, part of the decision logic elicitation process happens, for example, during informal discussions, professional gatherings or via emails, with no unified traceability or management of any sort. Thus, with current available systems, it is impossible to trace back the decisions implemented in automated or manual business processes to the true business rationale, and it is also impossible to understand the logic.

The approach in the art for Decision Management systems and Business Rules Management systems to solve these issues has been to create repositories where information is shared across the organization. These repositories are currently based on Source Code Management systems. A Source Code Management system is software that enables coordination between members of a product development team by providing file management and version control for the various artifacts so that team members don't write over each other's changes, and only the newest versions of files are identified for use in the workspace. Typically in these systems, the decisions or rules encoding those decisions are treated as source code which can be locked by any single user at a point in time. Each revision is logged into the repository with the ability to review history and revert to a past version.

An extension to versioning principles is to create a “branch” in which a subset of authorized authors can work on a section of the repository, versioning changes in the branch, before said branch is “merged” with the rest of the repository. With this method, modifications applied in parallel by other users may possibly be considered as well.

An additional extension provided by Business Rules Management systems is the support for a maker-checker paradigm for business rules, allowing one author to submit a newly created or newly modified rule to one single person in the group who has the authority to approve. This approach establishes a business controlled process for implementing new decisions or modifying existing decisions.

### SUMMARY OF THE INVENTION

The present invention is a method of collaborating on a decision within a decision bubble. A decision bubble, which is a closed environment by invitation shared by the bubble collaborators, as well as a group of candidate collaborators are created. The bubble owner selects the bubble collaborators from the candidate collaborators then the candidate collaborators are invited to join the decision bubble as bubble collaborators. The bubble collaborators provide and input contextual data into the decision bubble and the contextual data is stored in a memory. Recommended decision logic based on the data is programmatically computed without human intervention then displayed to the bubble owner or to the bubble collaborators.

### BRIEF DESCRIPTION OF THE DRAWINGS

FIG. 1 details a flowchart of an overview of the process of the present invention.

FIG. 2 depicts the decision bubble being generated and candidate collaborators being invited in the present system.

FIG. 3 illustrates the candidate collaborator accepting or declining to participate in the decision bubble.

FIG. 4 depicts operation within the decision bubble.

### DETAILED DESCRIPTION OF THE EMBODIMENTS

The following description is presented to enable a person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims. Reference now will be made in detail to embodiments of the disclosed invention, one or more examples of which are illustrated in the accompanying drawings.

A decision bubble is a specifically created environment in which a group of collaborators can interact with the purpose of creating and modifying decisions or business rules. During the process, the system captures all interactions between collaborators and enables full traceability with respect to the resulting decisions. Using a lightweight business process, a decision bubble is initiated and created by a business user, the bubble owner, and may contain in its scope any section of the decision being managed. The bubble owner may issue invitations to collaborators, some of which may be suggested by the system using a reputation system that rates users with respect to types of tasks and entities. The decision bubble contains all the contextual data required for the bubble collaborators to collaborate on the implementation or modifications of the decisions or rules. In one embodiment, the contextual data may be suggested by the system based on stated decision objectives and existing constraints.

The decision bubble provides all invited candidate collaborators with the contextual information on the bubble, combined with the information, specific to each of the candidate collaborators, on what the impact of accepting the bubble is on their environment at that point. Once the candidate collaborators enter the decision bubble thus becoming a collaborator, the collaborator is allowed full access to the contextual information. The collaborator is provided with the ability to exchange information on the corresponding decisions, modify a decision or another artifact in the decision bubble and collaborate on all such items through multiple channels. Also, each bubble collaborator is provided with privileges allowing specific operations with respect to the items of the decision bubble, the bubble collaborators or the bubble itself to be performed.

Only the users within the bubble can see and manage the newly created or modified decisions or rules. The bubble collaborators may jointly or separately collaborate on the items within the decision bubble and share the resulting modifications.

When the changes are deemed final by the bubble collaborators, a bubble collaborator with the proper privilege terminates the decision bubble and all other bubble collaborators are notified. The decision bubble may be merged back to the current state of the decisions, and the system keeps track of all interactions that led to the changed decisions, as well as all participants involved. This is stored in a memory, persistent storage or repository.

Finally, bubble collaborators may provide feedback on the interactions with any subgroup of the collaborators with respect to all or any subset of the interactions within the bubble. This feedback is tracked by the system and used to compute reputation scores.

The invention addresses the collaborative aspect of the decision logic elicitation phase inside of a decision bubble. In one embodiment, the decision bubble may be a closed environment by invitation shared by those participating in the collaborative effort. In another embodiment, this environment is open to collaboration by anyone without any limitation based on ranking and/or selection. Ad-hoc working groups are encouraged and enabled to form dynamically by invite, potentially recommending relevant experts to participate in the conversation. In one embodiment, the decision bubble consists of live collaboration where all collaborators work online viewing and editing the same entities, sharing the same view. In another embodiment, collaborators work online at the same time, but in isolation. In yet another embodiment, the decision bubble may be worked on independently by the collaborators then the results are merged back into the decision bubble.

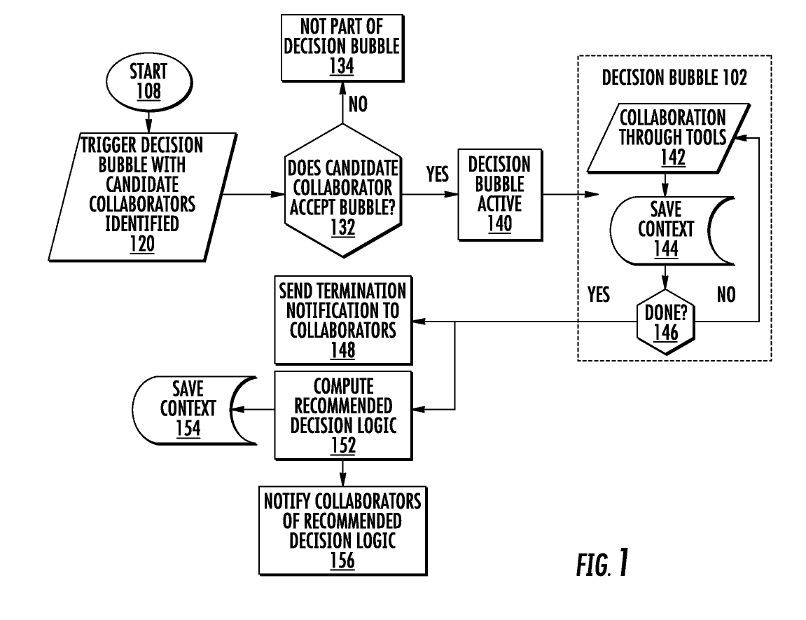

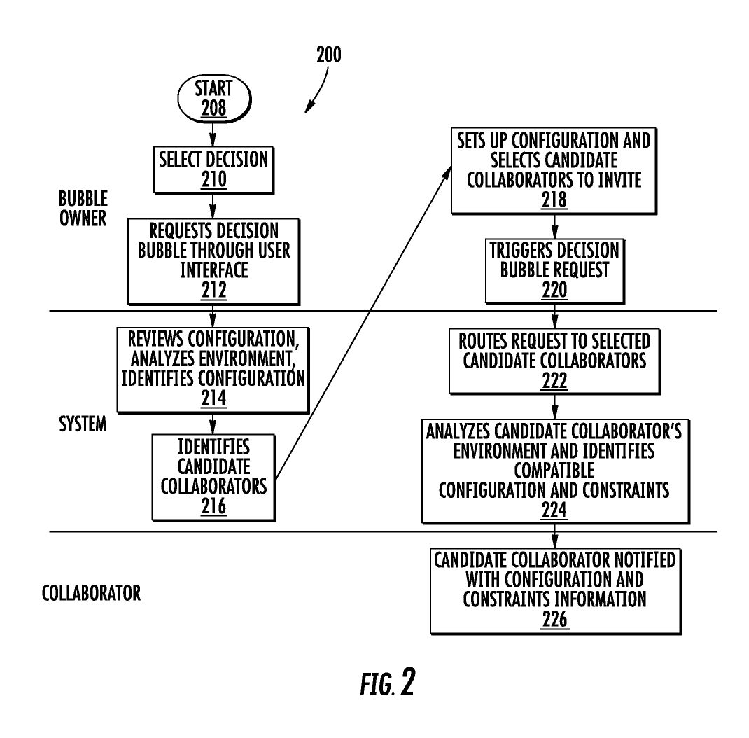

The invention provides contextual data relevant to the decision logic elicitation during the collaboration. It also tracks contributions and communications for later review and helps create decision logic by allowing dynamic input from multiple users working simultaneous or in isolation. A reputation-based mechanism is used to select a proposal for initial collaborators and to configure the decision bubble in the most appropriate way possible for the business objective being sought, and the project constraints. Lastly, social feedback may be provided within or outside of the decision bubble. FIG. 1 is an overview of the process of the present invention. Refer to FIGS. 2, 3 and 4 for specific example definitions and details on the embodiments.

Referring to FIG. 1, the process starts at step 108. In this embodiment, a user is interested in collaborating with other participants in the same network on the configuration of a particular decision. This decision may relate to a company purchase, a new business practice, a company acquisition or anything of the like. At step 120, the user triggers a decision bubble and identifies candidate collaborators. Each candidate collaborator has the option to decline or accept the decision bubble invitation at step 132. If a candidate collaborator declines at step 134, then that candidate collaborator is not part of the decision bubble. However, if a candidate collaborator accepts the invitation to join the decision bubble, then the decision bubble becomes active at step 140.

Inside decision bubble 102, more collaborators may be added. The collaborators collaborate through tools configured in the software at step 142. These tools include, for example, capabilities to edit and view the contents inside of the decision bubble. The system tracks all activity within the decision bubble and stores it in a memory at step 144. Once the bubble owner (also referred to as a requester) determines the goal is reached (step 146), the decision bubble is terminated. At step 148, a termination notification is sent to all collaborators. At step 152, the recommended decision logic is computed and the context is saved at step 154. The collaborators are notified of the recommended decision logic or results at step 156.

FIG. 2 depicts one embodiment for the decision bubble being generated and candidate collaborators being invited in the present system 200. For example, a user may be interested in collaborating with other participants in the same network on the configuration of a particular decision. The participants or candidate collaborators may include, for example, the decision bubble owner, peers, experts, or a group of professionals or more generally, any person or role able to contribute or benefit from the interactions around the items in the decision bubble. The process starts at step 208. To aid the user through the process, a software wizard tool or setup assistant may be used. This wizard tool is a user interface type that presents a user with a sequence of dialog boxes and leads the user through a series of well-defined steps. In other embodiments, the user may be guided through by drop-down menus or by an expert system which guides a user through a series of yes/no questions. Other commercially available techniques may be used to walk the user through the options.

At step 210, the user or requester selects the decision or decision elements for collaboration which may include relevant data, decision logic, or a decision itself. Moreover, the relevant data may be, but is not limited to, supporting documents, statistics, external sources of information, or other types of information. At step 212, the user triggers a command through a user interface to request a decision bubble for the selected entities. This user or requester of the decision bubble is now the bubble owner. The decision bubble may also be referred to as a collaboration bubble.

At step 214, the system reviews the configuration for the selected decision or decision element, as well as the configuration for the user's network. The decision or decision element configuration may include the contextual data in which the decision or decision elements reside and/or the context in which the user is creating, modifying and testing the decisions. The contextual data consists of items that are relevant to the decisions that need to be worked on. For example, contextual data may be forms, data sets, decision trees and graphs or business rules. In contrast, regular data may be the type included as text in a form, such as personal data on an application. The configuration may include other system users that are connected to the user or other system users who may have worked with the same project, related projects, or similar problems. From that analysis, the system derives information to propose a decision bubble configuration. This information may include sections of the project that are relevant to understanding the context of the decision bubble, as well as candidate collaborators to participate in the decision bubble.

At step 216, candidate collaborators are identified. The candidate collaborators may be assigned a reputation ranking, and this ranking may include a reputation score. The ranking may be based on, for example, a rating of the candidate's previous work, the expertise level in the subject matter of the contextual data, previous experience with the contextual data, or input and comments from peers. The quantitative ratings are determined by the system based on subject matter of the contextual data, previously received input from other users of the system, as well as assessments from the system of the quality and value of their contributions to the decisions and their business value. The rating of the quality of the bubble collaborators may be performed by the bubble owner or any bubble collaborator with the appropriate privileges, and the rating of the quality of the contextual data may be performed by the bubble owner or the bubble collaborators.

The wizard tool presents information to the bubble owner providing details on the recommended configuration and candidate collaborators, as well as an explanation on why that configuration was selected. At step 218, the bubble owner reviews the configuration and candidate collaborators and has the option, for each configuration element, to override the recommendation and provide his or her own choice. In one embodiment of the present system, the bubble owner selects the candidate collaborators, at least in part, based on the rankings of the candidate collaborators. In another embodiment, the bubble owner selects the candidate collaborators for the decision bubble without taking the rankings into consideration.

At step 220, the bubble owner triggers the decision bubble by selecting the proper option with the aid of the wizard tool, and a notification that a decision bubble is requested is transmitted. Further interactions are triggered as responses are returned.

The system routes the decision bubble request for collaboration to all identified candidate collaborators at step 222. This is accomplished by using channels and modalities as configured in the system for each user while respecting access control privileges.

As each candidate collaborator receives the request but prior to the request being presented, the system analyzes the request in order to determine how the candidate collaborator's configuration will accommodate collaborative work at step 224. For example, in one embodiment of the present system, a co-collaborator working on the same workspace is allowed to directly manipulate the entity and test data the same way as the bubble owner. In another embodiment, the co-collaborator may only be able to interact with the bubble owner and potentially run the resulting changes to the entity for verification.

At step 226, the candidate collaborator is notified of the bubble request along with the impact of configuring for collaboration and the constraints that configuration implies. The candidate collaborator then decides whether or not to accept to participate in the decision bubble. In one embodiment of the present system, the system may provide an incentive for participating in the decision bubble. The incentive may be financial or another tangible or non-tangible benefit.

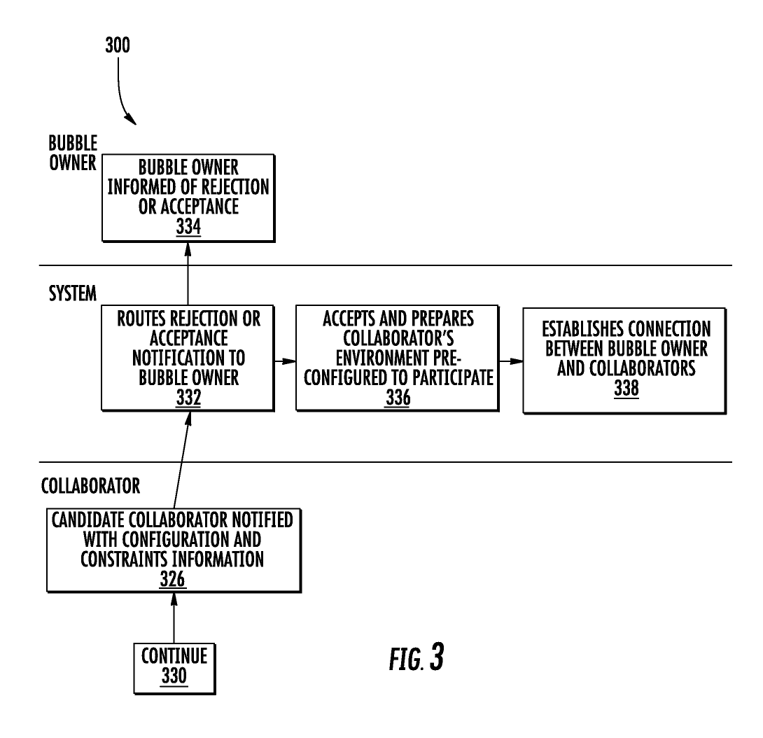

FIG. 3 illustrates the candidate collaborator accepting or declining to participate in the decision bubble. Referring to FIG. 3, the process continues at step 330. At step 326, each candidate collaborator receives a notification that a decision bubble has been requested with system-generated information described above. The level of detail in the request varies with the level of access control privilege relative to the entity of the bubble per candidate collaborator. For example, in one embodiment of the present system a co-collaborator may receive all the details about the decision bubble. In a further embodiment, a co-collaborator who is a specialist outside the firm may receive only a high level description of the request.

The candidate collaborator may decline or accept to participate in the decision bubble. A notification is generated and for a rejection, a reason may be indicated. The system routes the outcome to the decision bubble owner at step 332 and the bubble owner is notified at step 334. For an acceptance, the system marks the candidate collaborator's environment indicating that the decision bubble to waiting to start.

Once the bubble owner receives an acceptance notification from a candidate collaborator, the bubble owner can choose to start the decision bubble with that particular candidate collaborator at any time. With the optional aid of the wizard tool, the bubble owner selects the appropriate command in the notification forms presented by the system. Once a candidate collaborator is participating in the decision bubble, he or she is considered a collaborator.

At step 336, the system prepares the bubble owner's environment for the decision bubble enabling it to start. At step 338, the system connects the environments for the bubble owner and the chosen candidate collaborators so that the collaborators can see the entities for which the bubble was created in the context prepared for each of them. In one embodiment, the connection between these environments enables each user to modify the entities, and also to be privy to any modifications or input another collaborator executes in real-time. In one embodiment, the decision bubble can be overlaid on the candidate collaborators workspace effectively merging the content of the bubble with the content of the workspace.

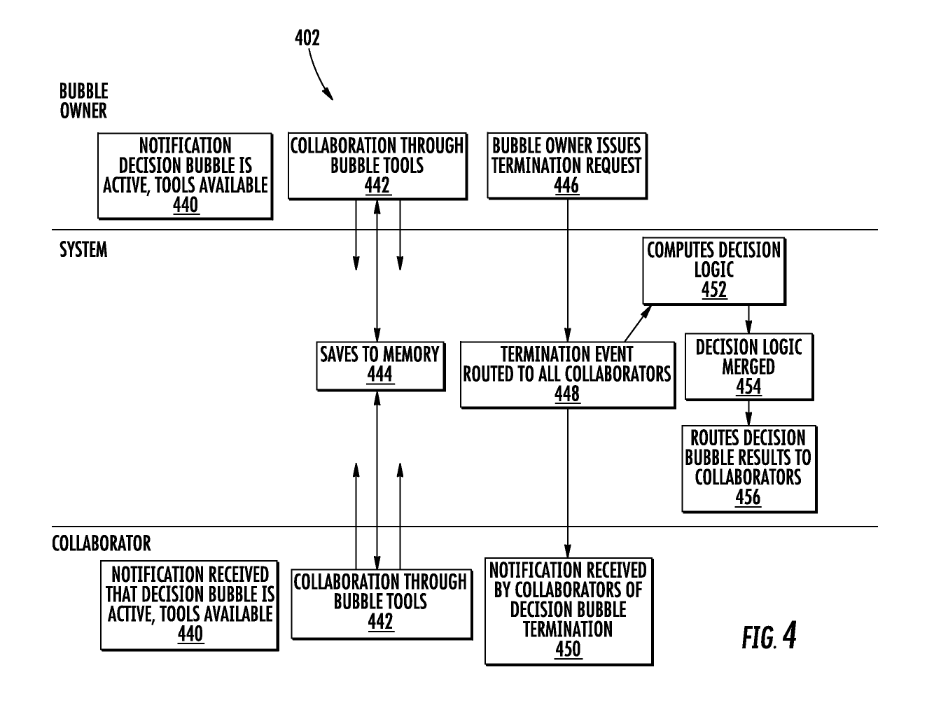

FIG. 4 depicts operation within the decision bubble corresponding to step 402. At step 440, the bubble owner activates the decision bubble and notification is sent to the bubble collaborators. In the context of the decision bubble and in addition to the shared environment, the system makes available to each collaborator a series of tools (step 442) that enable the collaborators to exchange information or contextual data in real-time. The contextual data may include, but is not limited to, data the collaborators use to form decisions such as company business rules, case histories, regulations, existing decision logic and working data sets. The information may be exchanged, for example, through instant messages, or links to other documents.

The system tracks all changes, contextual data and information exchanged during the decision bubble and stores it persistently in a memory at step 444. For example, inside of the decision bubble, the collaborators working on the project may make changes to data, contribute to a decision or create a new business rule. These aspects are documented by collaborator and saved. The persistence storage, memory or repository may be located remote from the user devices. Collaborators may enter and exit the decision bubble and also explore what has occurred during the collaboration within the decision bubble in a chronological fashion.

In further embodiments, bubble owners and collaborators may provide social feedback on any item within the decision bubble. The item may or may not have been modified and the post may be by any collaborator. For example, if a collaborator modifies context within a document, the same collaborator may post a comment directly on the item stating a reason for the modification. Also, a collaborator may post social feedback on an item modified by another collaborator. Further, a bubble owner may post a comment requesting a particular collaborator to modify a document. Finally, a collaborator may post a comment with positive or negative opinions about an item.

At any point in time, the bubble owner or any bubble collaborator with the appropriate privileges may add or remove collaborators to the decision bubble or change the bubble owner. This is executed by issuing requests, optionally assisted with the wizard tool.

In one embodiment, at any point in time, the bubble owner or any bubble collaborator with the appropriate privileges may terminate the decision bubble (step 446). To do so, the bubble owner selects the appropriate command in the system. The wizard tool may be used to lead the bubble owner or any bubble collaborator with the appropriate privileges through the process of deciding which modifications and changes to the entity to keep, and also document the reason for the changes. The bubble owner or any bubble collaborator with the appropriate privileges may decide to keep no changes, or may keep the changes up to any level, including a complete set of changes. In another embodiment of the present system, a collaborator may terminate his or her involvement in the decision bubble at any time.

At step 448, a notice of termination of the decision bubble is sent by the system triggered by the bubble owner or any bubble collaborator with appropriate privileges to all collaborators and at step 450, the collaborators receive the notification that the decision bubble is terminated. In another embodiment, a termination message may be posted by the bubble owner for all collaborators.

At step 452, after the decision bubble is terminated, the decision logic modified by the bubble collaborators is merged with the rest of the decisions at step 454. At step 456, the recommended decision logic or results may be sent to the collaborators.

The bubble owner or any bubble collaborator may be presented with the option to rate the collaborators performance and save that information for future use in other decision bubbles. The system commits the complete change and information trail to persistent storage, memory or repository, enabling later reviews of the decision bubble.

In one embodiment of the present system, the decision bubble consists of live collaboration where all collaborators are working online viewing and editing the same entities, sharing the same view. When one collaborator edits one entity, everyone in the decision bubble sees the change real-time in their session. In another embodiment of the present system, collaborators maybe working online at the same time, but in isolation. In this scenario, the collaborator has a copy of the project. Collaborators can discuss the impact of changes and can tweak and test the content independently before submitting to the decision bubble for all to view. In yet another embodiment, the decision bubble could alternatively be opened and worked on independently by the collaborators then the result is sent to the decision bubble and/or the bubble owner.

In another embodiment, a collaborator may be participating in more than one decision bubble at the same time. In this embodiment, there is no limit in the amount of decision bubbles a collaborator may be participating in at the same time. Also, there is no limit to the amount of decision bubbles active or inactive on a collaborator's workspace.

In another embodiment, the bubble owner may use the decision bubble in a competitive manner between collaborators. For example, the bubble owner may conduct a contest to find out which collaborator returns the highest quality of work product in the shortest amount of time. In this instance, the collaborator has a copy of the project and works in isolation. The collaborator may not know if there are other collaborators or if there are other collaborators, the collaborator may not know their identity. In this embodiment, some collaborators may or may not have visibility into another collaborator's work while the latter collaborator may not know they are being monitored or who is monitoring their work. For example, in a human resources application, a collaborator may not know if there is monitoring by the bubble owner or by others during the collaboration process.

In further embodiments, bubble owners and collaborators may provide social feedback on one another within or outside of the decision bubble. For example, a bubble owner or collaborator may post a comment with positive or negative opinions about a co-collaborator's performance, proficiency, expertise, quality of work or attitude. This information may be used toward the reputation ranking and may be viewed by all collaborators and peers or a select few. The present invention is a valuable tool for management as well. Because the activity within the decision bubble is tracked and saved, management may use this information to assess the contribution of each collaborator. Or it may be of interest to management to view the collaborator's ranking, or read social feedback comments on a particular collaborator which is provided within the process.

An example of specific embodiments will now be presented to demonstrate the present invention. The invention is not defined or limited by this example, and this example is merely presented for illustrative purposes.

In this example, an automobile insurance underwriter makes a manual decision as to whether to underwrite an automobile insurance application. If so, a quote will be provided to the applicant based on the information provided. Unfortunately, the underwriter does not have the experience or expertise to make the decision for applications involving a certain demographic group (i.e. young drivers) and needs to solicit input from necessary team members in the company. The underwriter creates a decision bubble to decide if a client aged 21 years old with three accidents on their driving record seeking insurance for a sport car will qualify for an insurance policy.

The underwriter is now the bubble owner. As the decision bubble is created, candidate collaborators are suggested based on their reputation with respect to the underwriting decision for the demographic in question, such as, for example, a peer on the underwriting team with many years of experience, a legal compliance expert and a business rule author within the company. Decision bubble requests are sent to the candidate collaborators and all accept to participate. Thus, the collaborators are an experienced peer, a legal compliance expert and a business rule author. In this embodiment, all collaborators work on the decision bubble at the same time, sharing the same view.

Inside the decision bubble, collaborators share information, discuss and exchange ideas. For example, the bubble owner shares data about the driver contained on a company standardized form such as the address, driving record and mileage driven per year. The experienced peer introduces data sets of case histories to be reviewed and studied. The legal compliance expert shares documents with regulations pertaining to the particular state where the client lives. The business rule author communicates the existing pool of company business rules regarding the subject matter.

Through collaboration, discussions are held, data are shared and edits are made which may be tested and refined. Also, reports and statistics may be generated allowing the comparison of decision performance indicators and the verification with regulatory compliance. From this effort, it may be decided that a new business rule needs to be written and implemented company wide. The new business rule, for example, will reject a client seeking insurance if the driver is aged 21 years or less residing in California, has 3 or more accidents on their driving record and their primary vehicle for insurance is a sports car.

The history of the interactions within the decision bubble as well as the contributing collaborators are recorded and saved. The collaborators may provide social feedback as well. Therefore, the bubble owner may choose to leave positive feedback about working with the legal compliance expert. The bubble owner then terminates the decision bubble, saves the new business rule and enters it into the repository for the entire company to access.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed is:

1. A method of collaborating on a decision within a decision bubble, the method comprising the steps of:
creating a decision bubble;
creating a group of candidate collaborators;
inviting one or more candidate collaborators to join the decision bubble as bubble collaborators;
enabling a bubble owner to select the bubble collaborators from the candidate collaborators;
receiving contextual data and inputting the contextual data into the decision bubble, the contextual data being provided by the bubble collaborators;
storing the contextual data in a memory;
programmatically computing recommended decision logic based on the data without human intervention;
outputting data for displaying the recommended decision logic to the bubble owner or to the bubble collaborators;
wherein the decision bubble is a closed environment by invitation; and
wherein the closed environment is shared by the bubble collaborators.

2. The method of collaborating on a decision in a decision bubble of claim 1, wherein the bubble collaborators consist of the decision bubble owner, peers, experts or a group of professionals.

3. The method of collaborating on a decision in a decision bubble of claim 1, wherein the creating a group of candidate collaborators is based on input from at least one user.

4. The method of collaborating on a decision in a decision bubble of claim 1, further comprising the step of rating the quality of the contextual data, the rating being done by the bubble owner or the bubble collaborators.

5. The method of collaborating on a decision in a decision bubble of claim 1, further comprising the step of rating the quality of the bubble collaborators, the rating being done by the bubble owner or the bubble collaborators

6. The method of collaborating on a decision in a decision bubble of claim 1, further comprising the step of ranking the candidate collaborators, wherein the ranking is based on subject matter of the contextual data, previously received input from other users and assessments from other decision bubbles.

7. The method of collaborating on a decision in a decision bubble of claim 6, wherein the enabling of the bubble owner to select the bubble collaborators from the candidate collaborators is based at least in part on the ranking

8. The method of collaborating on a decision in a decision bubble of claim 1, further comprising the step of terminating the decision bubble at any time by the decision bubble owner or one of the bubble collaborators when the one of the bubble collaborators has appropriate privileges.

9. The method of collaborating on a decision in a decision bubble of claim 1, further comprising the step of receiving social feedback from the bubble owner or the bubble collaborators while the bubble owner or the bubble collaborators are inside or outside the decision bubble.

10. The method of collaborating on a decision in a decision bubble of claim 1, further comprising the step of utilizing a software wizard to aid the bubble owner or the bubble collaborators.

11. A method of collaborating on a decision within a decision bubble, the method comprising the steps of:
creating a decision bubble;
creating a group of candidate collaborators;
inviting one or more candidate collaborators to join the decision bubble as bubble collaborators;
enabling a bubble owner to select the bubble collaborators from the candidate collaborators;
receiving contextual data and inputting the contextual data into the decision bubble, the contextual data being provided by the bubble collaborators;
storing the contextual data in a memory;
programmatically computing recommended decision logic based on the data without human intervention;
outputting data for displaying the recommended decision logic to the bubble owner or to the bubble collaborators;
wherein the decision bubble is an open environment;
wherein the bubble collaborators work independently; and
wherein results from the work is sent to the decision bubble and/or the bubble owner.

12. The method of collaborating on a decision in a decision bubble of claim 11, further comprising the step of receiving social feedback from the bubble owner or the bubble collaborators while the bubble owner or the bubble collaborators are inside or outside the decision bubble.

13. The method of collaborating on a decision in a decision bubble of claim 11, further comprising the step of rating the quality of the contextual data, the rating being done by the bubble owner or the candidate collaborators.

14. The method of collaborating on a decision in a decision bubble of claim 11, further comprising the step of rating the quality of the bubble collaborators, the rating being done by one of the bubble collaborators.

15. The method of collaborating on a decision in a decision bubble of claim 11, further comprising the step of ranking the candidate collaborators, wherein the ranking is based on the subject matter of the contextual data, previously received input from other users, or assessments from other decision bubbles..

16. The method of collaborating on a decision in a decision bubble of claim 15, wherein the enabling of the bubble owner to select the bubble collaborators from the candidate collaborators is based at least in part on the ranking.

17. A method of collaborating on a decision within a decision bubble, the method comprising the steps of:
creating a decision bubble;
creating a group of candidate collaborators;
inviting one or more candidate collaborators to join the decision bubble as bubble collaborators;
enabling a bubble owner to select the bubble collaborators from the candidate collaborators;
receiving contextual data and inputting the contextual data into the decision bubble, the contextual data being provided by the bubble collaborators;
storing the contextual data in a memory;
programmatically computing recommended decision logic based on the data without human intervention;
outputting data for displaying the recommended decision logic to the bubble owner or to the bubble collaborators; and
receiving social feedback from the bubble owner or the bubble collaborators while the bubble owner or the bubble collaborators are inside or outside the decision bubble.

18. The method of collaborating on a decision in a decision bubble of claim 17, further comprising the step of rating the quality of the bubble collaborators, the rating being done by the bubble owner or one of the bubble collaborators.

19. The method of collaborating on a decision in a decision bubble of claim 17, further comprising the step of ranking the candidate collaborators, wherein the ranking is based on subject matter of the contextual data, previously received input from other users, or assessments from other decision bubbles.

20. The method of collaborating on a decision in a decision bubble of claim 19, wherein the enabling of the bubble owner to select the bubble collaborators from the candidate collaborators is based at least in part on the ranking
